(19) United States
(12) Patent Application Publication
(10) Pub. No.: US 2020/0312080 A1
(43) Pub. Date: Oct. 1, 2020

(54) Method, System and Apparatus for a Gambling System

(71) Applicant: Omni Consumer Products, LLC, Addison, TX (US)

(72) Inventors: Stephen Howard, Dallas, TX (US); Larry McNutt, Carrollton, TX (US); Robert Reynolds, Addison, TX (US)

(21) Appl. No.: 16/810,799

(22) Filed: Mar. 5, 2020

Related U.S. Application Data
(63) Continuation-in-part of application No. 15/394,799, filed on Dec. 29, 2016.
Application No. 15/394,799 is a continuation-in-part of application No. 15/258,973, filed on Sep. 7, 2016, now abandoned.
Application No. 15/258,973 is a continuation-in-part of application No. 14/535,823, filed on Nov. 7, 2014, now Pat. No. 9,465,488.
Application No. 14/535,823 is a continuation-in-part of application No. 13/890,709, filed on May 9, 2013, now Pat. No. 9,360,888.
Application No. 13/890,709 is a continuation-in-part of application No. 14/985,044, filed on Dec. 30, 2015.
Application No. 14/985,044 is a continuation-in-part of application No. PCT/US2015/068192, filed on Dec. 30, 2015.
(60) Provisional application No. 62/814,263, filed on Mar. 5, 2019.

(51) Int. Cl. G07F 17/32

(52) U.S. Cl. CPC G07F 17/3211; G07F 17/3206; G07F 17/322; G07F 17/323; G07F 17/3237; G07F 17/3209

(57) ABSTRACT

A counting method, apparatus and system. The gambling apparatus includes a processor, a power module, an analysis module, a memory, and a capturing device module. The processor, the power module, the analysis module, the memory, and the capturing device are coupled at least in one of wirelessly or connected. The capturing device captures images of at least one zone on a gambling surface and presents an interactive image on the gambling surface and wherein the gambling analysis module determines at least one of movement over the at least one zone, number of objects, tracking of an object, facial recognition, and relationship between individuals and the zone.

### CROSS REFERENCE TO RELATED APPLICATIONS

This Application claims priority to U.S. Provisional Applications 62/814,263 filed on Mar. 5, 2019. This application is also a continuation-in-part of U.S. application Ser. No. 15/394,799, filed on Dec. 29, 2016, which is a continuation-in-part of U.S. application Ser. No. 15/258,973, filed on Sep. 7, 2016, a continuation of U.S. application Ser. No. 14/535,823 filed Nov. 7, 2014, which is a continuation-in-part of U.S. application Ser. No. 13/890,709 filed May 9, 2013. This application is also a continuation-in-part of U.S. application Ser. No. 14/985,044 and PCT Application No. PCTU/US2015/068192 both filed on Dec. 30, 2015. The above identified patent applications are incorporated herein by reference in their entirety to provide continuity of disclosure.

### FIELD OF THE INVENTION

The disclosure relates to systems, apparatus and methods for a gambling system. More specifically, this disclosure relates to utilizing computer vision and image analysis to make determinations related to gambling and to present an experience to gamblers.

### BACKGROUND OF THE INVENTION

Dealers and gamblers gather around a gambling table and interact using cards, signs, chips, etc. The table is usually not interactive, and the gambling setup does not provide any interactive tools for the dealer or the gamblers. Dealers estimate the amount wagered by looking from a distance or reaching out across a table to count chips. Therefore, there is a need for an advanced gambling setup.

### SUMMARY OF THE INVENTION

Embodiments described herein relate to a method, apparatus and system for a gambling. The gambling apparatus includes a processor, a power module, an analysis module, a memory, and a capturing device module. The processor, the power module, the analysis module, the memory, and the capturing device are coupled at least in one of wirelessly or connected. The capturing device captures images of at least one zone on a gambling surface and presents an interactive image on the gambling surface and wherein the gambling analysis module determines at least one of movement over the at least one zone, number of objects, tracking of an object, facial recognition, and relationship between individuals and the zone.

### BRIEF DESCRIPTION OF DRAWINGS

Reference will now be made to the following drawings:

FIG. 1 is a block diagram illustrating an embodiment of a gambling apparatus for a gambling surface;

FIG. 2 is a diagram illustrating an embodiment of a system for utilizing the gambling apparatus;

FIG. 3 is a diagram illustrating another embodiment of a system for utilizing the gambling apparatus; and

FIG. 4 is a diagram illustrating an embodiment of the output of a gambling apparatus; and

FIG. 5 is a block diagram illustrating a method for a gambling apparatus.

### DETAILED DESCRIPTION

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

It will be appreciated by those skilled in the art that aspects of the present disclosure may be illustrated and described herein in any of a number of patentable classes or context including any new and useful process, machine, manufacture, or composition of matter, or any new and useful improvement thereof. Therefore, aspects of the present disclosure may be implemented entirely in hardware or combining software and hardware implementation that may all generally be referred to herein as a “circuit,” “module,” “component,” or “system” (including firmware, resident software, micro-code, etc.). Further, aspects of the present disclosure may take the form of a computer program product embodied in one or more computer readable media having computer readable program code embodied thereon.

Any combination of one or more computer readable media may be utilized. The computer readable media may be a computer readable signal medium, any type of memory or a computer readable storage medium. For example, a computer readable storage medium may be, but not limited to, an electronic, magnetic, optical, electromagnetic, or semiconductor system, apparatus, or device, or any suitable combination of the foregoing. More specific examples of the computer readable storage medium would include, but are not limited to: a portable computer diskette, a hard disk, a random access memory (“RAM”), a read-only memory (“ROM”), an erasable programmable read-only memory (“EPROM” or Flash memory), an appropriate optical fiber with a repeater, a portable compact disc read-only memory (“CD-ROM”), an optical storage device, a magnetic storage device, or any suitable combination of the foregoing. Thus, a computer readable storage medium may be any tangible medium that can contain, or store a program for use by or in connection with an instruction execution system, apparatus, or device.

Computer program code for carrying out operations utilizing a processor for aspects of the present disclosure may be written in any combination of one or more programming languages, markup languages, style sheets and JavaScript libraries, including but not limited to Windows Presentation Foundation (WPF), HTML/CSS, XAML, and JQuery, C, Basic, *Ada, Python, C++, C#, Pascal, *Arduino. Additionally, operations can be carried out using any variety of compiler available.

Aspects of the present disclosure are described herein with reference to flowchart illustrations and/or block diagrams of methods, systems and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, processor, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, processor, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

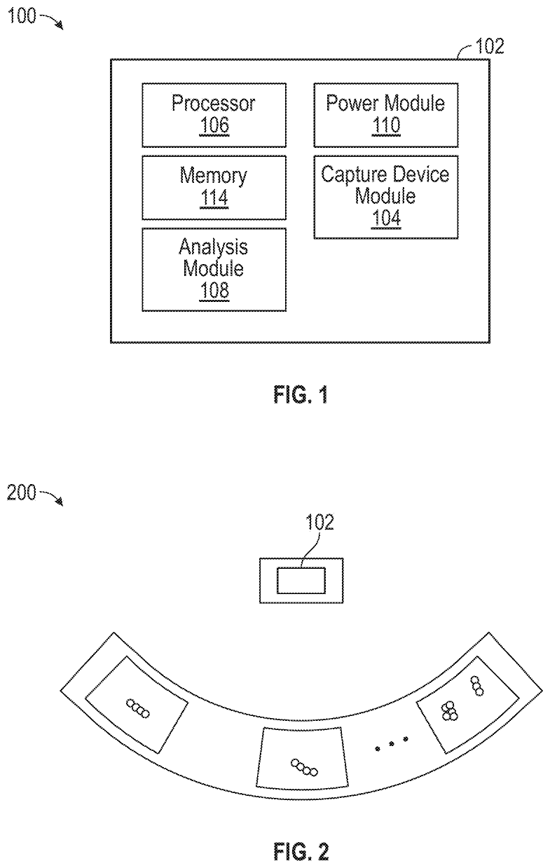

FIG. 1 is a block diagram illustrating an embodiment of a gambling apparatus 100 for a gambling surface. The gambling system 100 includes recognition module 102. The recognition module 102 includes a capturing device module 104, a processor 106, analysis module 108, power module 110, and memory 114.

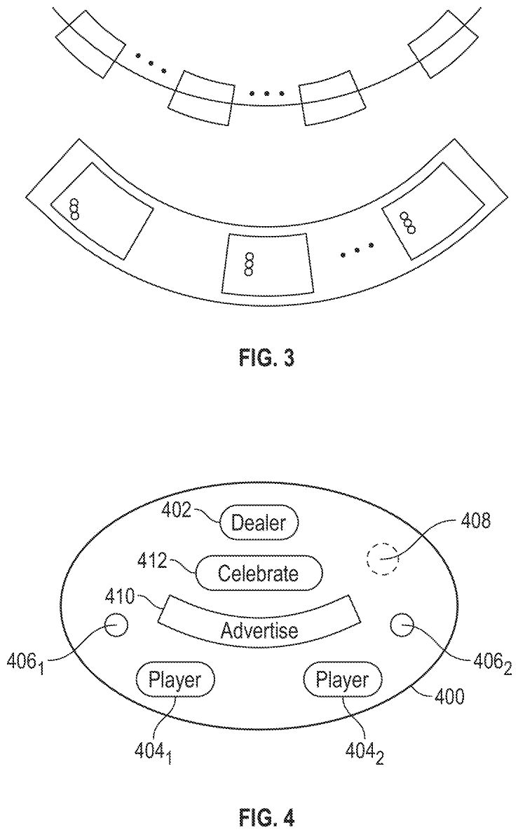

In one embodiment, the recognition module 102 is place at an angle to have clear view of all items on a table. As shown in FIG. 3, more than one recognition module 102 may be used over a gambling surface, such as a gambling table, a roulette, and the like. In one embodiment, the series of counting modules 102 may be scattered across the gambling surface, in an arch shape over the table, across from the players, in any format, etc.

The image capturing device module 104 may include a single or multiple capturing devices, such as, a camera, a camcorder, projector a zoom-in lens camera, and the likes. The capturing device may include both a camera and a projector. As such, the camera captures images and the projector displays an interactive image on the gambling surface. The analysis module 108 is capable of learning over time the different attributes presented, various colors, schemes, patterns, sizes, etc. The analysis module 108 can track and can determine the number of items per color presented on a gambling surface. As such, in one embodiment, the analysis module 108 is capable of calculating the amount waged, the number of chips per color, the number of cards, cards location and path, can track playing cards, and/or the location of the wage. In another embodiment, the analysis module retrieves the color, pattern, size information, without the need to learn it or determine it. The analysis module 108 is capable of determining the number of deals per dealer, recognize players and/or dealers, determine player habits, etc. The memory 114 is used to archive any data, executable instructions or the like. The power module 110 may be battery operated, electric, solar, combination thereof or any source of power.

FIG. 2 is a diagram illustrating an embodiment of a system 200 for utilizing the gambling apparatus 100. The system 200 utilizes the recognition module 102. The product apparatus 200 identifies products to determine the items and/or amount of items placed on a gambling surface in a specific location. FIG. 2, depicts a single recognition module 102. However, any number of recognition module 102 may be utilized. In one embodiment, the recognition module 102 is placed at an angle to facilitate a better view.

FIG. 4 is a diagram illustrating an embodiment of the output of a gambling apparatus 100. The output is displayed on a gambling surface 400; herein presented as a table but also may be any gambling surface, such as a roulette table, a slot machine surface or the like. The gambling surface 400 may include a dealer zone 402 for identifying cards, coins, or had gestures made by the dealer. The gambling apparatus 102 may determine the number of deals per dealer by identifying the dealer and counting the number of deals dealt in the dealer zone 402. The gambling apparatus 200 may present different displays in the advertising portion 410 or the celebration portion 412 based on the dealer's gestures, items in the dealer zone 402 and the like. The table surface 400 may include a visible button, such as, button 406₁ and 406₂. As such, the visible button 406₁ and 406₂ maybe a waitress button or a help button that players 404₁ and 404₂ may respectively use. Player zones 404₁ and 404₂ are zones that may be identifies with the individuals placed adjacent to the player zones 404₁ and 404₂. As such, cards, items, hand gestures and other activities in these zones are directly related to the respective players.

In one embodiment, the gambling apparatus 102 identifies gestures related to the invisible button 408. For example, the hand places on the invisible button 408 may trigger a request for help to security or the Pitt-Boss. In other embodiments, the invisible button 408 may trigger special offerings or advertisement to the players.

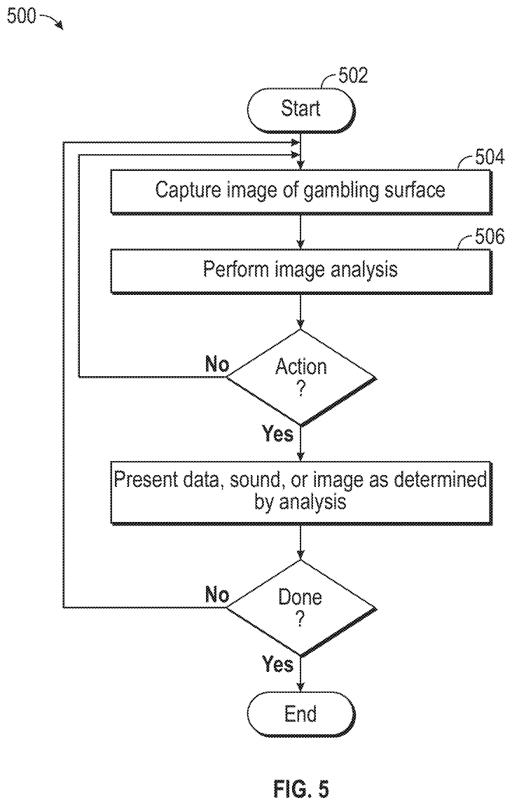

Referring now to FIG. 5, a method for a gambling apparatus is illustrated. At step 502, the method starts. At step 504, the method includes capturing an image of a gambling surface, such as, for example, a gambling table, a roulette table, or a slot machine. In some embodiments, the method captures images of at least one zone on a gambling surface and presents an interactive image on the gambling surface. The method further determines at least one movement over the at least one zone, the number of objects, tracking of an object, facial recognition, and relationship between individual and a zone. According to one embodiment, the zones relate to at least one of a dealer, at least one player, advertisements, celebrations, invisible buttons and visible buttons.

The method continues at step 506 by performing analysis on the captured image. For example, the analysis module determines the number of deals performed per dealer. In other embodiments, the analysis module performs face recognition to determine at least one of player habits, player relation to cards, player relation to chips, a winning player and a losing player.

At step 508, it is determined whether action is necessary. For example, at step 508 the method includes determining if action is necessary based on the analysis of the captured image. If action is necessary, the method continues to step 510 so that the action occurs. For example, in some embodiments, a commercial, advertisement, celebration graphic, menu, drink option, winning bonus and various zones can be displayed. If at step 508 it is determined that action is not necessary, the method returns to step 504 and repeats.

At step 512, it is determined whether or not the method is finished. If not, the method returns to step 504 and repeats.

It will be appreciated by those skilled in the art that changes could be made to the embodiments described above without departing from the broad inventive concept. It is understood, therefore, that this disclosure is not limited to the particular embodiments herein, but it is intended to cover modifications within the spirit and scope of the present disclosure as defined by the appended claims.

What is claimed is:

1. A gambling apparatus, comprising:
a processor, a power module, an analysis module, a memory, and a capturing device module, wherein the processor, the power module, the analysis module, the memory, and the capturing device are coupled at least in one of wirelessly or connected;
wherein the capturing device captures images of at least one zone on a gambling surface and presents an interactive image on the gambling surface and wherein the gambling analysis module determines at least one of movement over the at least one zone, number of objects, tracking of an object, facial recognition, and relationship between individuals and the zone.

2. The gambling apparatus of claim 1, wherein the zones relate to at least one of a deal, at least one player, advertisement celebration, invisible button, visible button.

3. The gambling apparatus of claim 1, wherein the capturing device displays on the gambling surface at least one of a commercials, advertisement, celebration graphics, menus, drink options, winning bonus and various zones.

4. The gambling apparatus of claim 1, wherein the analysis module performs face recognition and wherein the face recognition determines at least one of player habits, player relation to cards, player relation to chips, winning player, and losing player.

5. The gambling apparatus of claim 1, wherein the analysis module determines the numbers of deals performed per dealer.

6. The gambling apparatus of claim 1, wherein the gambling surface is at least one of a gambling table, a roulette, or a slot machine.

7. The gambling apparatus of claim 1, wherein the capturing device module comprises a camera and a projector.

8. The gambling apparatus of claim 7, wherein the camera and projector are adjacent and facing the same surface.

9. The gambling apparatus of claim 8, wherein the camera and projector face different surfaces.

10. The gambling surface of claim 7, wherein the camera and projector are not adjacent.

11. A method for a gambling apparatus, comprising:
capturing an image of a gambling surface;
performing analysis on the captured image;
determining if action is necessary based on the analysis of the captured image; and
present at least one of data, sound or image based on the analysis.

12. The method of claim 11, wherein the method captures images of at least one zone on a gambling surface and presents an interactive image on the gambling surface and wherein the method further determines at least one of movement over the at least one zone, number of objects, tracking of an object, facial recognition, and relationship between individuals and the zone.

13. The method of claim 11, wherein the zones relate to at least one of a deal, at least one player, advertisement celebration, invisible button, visible button.

12. The method of claim 11, wherein the method displays on the gambling surface at least one of a commercials, advertisement, celebration graphics, menus, drink options, winning bonus and various zones.

13. The method of claim 11, wherein the analysis module performs face recognition and wherein the face recognition determines at least one of player habits, player relation to cards, player relation to chips, winning player, and losing player.

14. The method of claim 11, wherein the analysis module determines the numbers of deals performed per dealer.

15. The method of claim 11, wherein the gambling surface is at least one of a gambling table, a roulette, or a slot machine.
